(19) United States
(12) Patent Application Publication
(10) Pub. No.: US 2026/0267790 A1
(43) Pub. Date: Sep. 10, 2026

(54) MEMORY SYSTEM AND METHOD

(71) Applicant: Kioxia Corporation, Tokyo (JP)

(72) Inventor: Mel Stychen SANCHEZ TAN, Yokohama Kanagawa (JP)

(21) Appl. No.: 19/323,580

(22) Filed: Sep. 9, 2025

(30) Foreign Application Priority Data
Mar. 6, 2025 (JP) 2025-035381

(51) Int. Cl. G06F 12/02

(52) U.S. Cl. CPC G06F 12/0246; G06F 2212/7201

(57) ABSTRACT

A memory system includes a nonvolatile memory including a plurality of storage regions, each of which includes a plurality of memory cells, and a controller electrically connected to the nonvolatile memory. The controller is configured to: in response to an inquiry command received from a host, the inquiry command including at least a first logical address, determine whether internal movement of first data corresponding to the first logical address is scheduled to be started within a predetermined amount of time from a receipt time of the inquiry command, and in response to determining that the internal movement of the first data is scheduled to be started within the predetermined amount of time from the receipt time of the inquiry command, transmit schedule information to the host, the schedule information indicating when the internal movement of the first data will be started.

### CROSS-REFERENCE TO RELATED APPLICATION(S)

This application is based upon and claims the benefit of priority from Japanese Patent Application No. 2025-035381, filed Mar. 6, 2025, the entire contents of which are incorporated herein by reference.

### FIELD

Embodiments described herein relate generally to a memory system including a nonvolatile memory and a method of notifying a host of information.

### BACKGROUND

In recent years, the use of a memory system including a nonvolatile memory has become widespread. As one type of such a memory system, a solid state drive (SSD) including a NAND flash memory is known. The SSD is used as a storage device of various hosts such as a server of a data center.

A host sometimes recognizes that data corresponding to a certain logical address is unnecessary. In this case, the host transmits a deallocate command concerning the unnecessary data to a memory system. The deallocate command is also referred to as a trim command or an unmap command.

The memory system sometimes moves data stored in a certain storage location to another storage location. The movement is referred to as internal movement. The memory system executes the internal movement independently of a request from the host. That is, the host is not aware of when the internal movement occurs. For that reason, the host sometimes transmits a deallocate command concerning the internally moved data to the memory system. In this case, the internal movement executed by the memory system before the reception of the deallocate command is unnecessary. The unnecessary internal movement excessively raises a write amplification factor (WAF). In addition, when timing of the internal movement and timing of an operation for an I/O command from the host overlap, the performance of the memory system is deteriorated.

### BRIEF DESCRIPTION OF THE DRAWINGS

FIG. 1 is a block diagram illustrating a configuration example of an information processing system including a memory system according to an embodiment.

FIG. 2 is a diagram for explaining an example of an address conversion table used in the memory system according to the embodiment.

FIG. 3 is a diagram for explaining a plurality of namespaces managed in the memory system according to the embodiment.

FIG. 4 is a diagram illustrating a configuration example of a memory chip included in the memory system according to the embodiment.

FIG. 5 is a diagram illustrating a configuration example of a super block in the memory system according to the embodiment.

FIG. 6 is a diagram for explaining an example of processing in the case in which the memory system according to the embodiment receives a setting command.

FIG. 7 is a diagram for explaining an example of a notification management table used in the memory system according to the embodiment.

FIG. 8 is a diagram for explaining an example of processing in the case in which the memory system according to the embodiment receives a write command.

FIG. 9 is a diagram for explaining an example of a nonvolatile memory in which data is written in the memory system according to the embodiment.

FIG. 10 is a diagram for explaining an example of a forced refresh management table used in the memory system according to the embodiment.

FIG. 11 is a diagram for explaining an example of processing in the case in which the memory system according to the embodiment receives an inquiry command.

FIG. 12 is a diagram for explaining an example of a notification transmitted by the memory system according to the embodiment.

FIG. 13 is a diagram for explaining another example of the forced refresh management table used in the memory system according to the embodiment.

FIG. 14 is a diagram for explaining another example of the notification transmitted by the memory system according to the embodiment.

FIG. 15 is a diagram for explaining an example of timing at which a host transmits a deallocate command to the memory system according to the embodiment.

FIG. 16 is a diagram for explaining an example of timing at which a host transmits a deallocate command to a memory system according to a comparative example.

FIG. 17 is a diagram for explaining an example of processing in which the memory system according to the embodiment receives a reservation command.

FIG. 18 is a diagram for explaining still another example of the forced refresh management table used in the memory system according to the embodiment.

FIG. 19 is a diagram for explaining still another example of the forced refresh management table used in the memory system according to the embodiment.

FIG. 20 is a flowchart for explaining an example of a procedure of forced refresh executed in the memory system according to the embodiment.

FIG. 21 is a diagram for explaining an example of a forced refresh list used in the memory system according to the embodiment.

### DETAILED DESCRIPTION

### Embodiments provide a memory system having high performance.

In general, according to one embodiment, a memory system includes: a nonvolatile memory including a plurality of storage regions, each of which includes a plurality of memory cells each configured to store data in accordance with a threshold voltage thereof; and a controller electrically connected to the nonvolatile memory. The controller is configured to: in response to an inquiry command received from a host, the inquiry command including at least a first logical address, determine whether internal movement of first data corresponding to the first logical address is scheduled to be started within a predetermined amount of time from a receipt time of the inquiry command, and in response to determining that the internal movement of the first data is scheduled to be started within the predetermined amount of time from the receipt time of the inquiry command, transmit schedule information to the host, the schedule information indicating when the internal movement of the first data will be started.

An embodiment is explained below with reference to the drawings. The following explanation provides examples of a device and a method for embodying the technical idea of the embodiment. The technical idea of the embodiment is not limited to structures, shapes, dispositions, materials, or the like of constituent elements explained below. Modifications that are readily conceived by those skilled in the art are naturally included in the scope of the disclosure. In order to further clarify the explanation, in the drawings, sizes, thicknesses, planar dimensions, shapes, or the like of elements are sometimes changed with respect to actual ones and schematically represented. A plurality of drawings sometimes include elements, whose relations and ratios of dimensions are depicted differently across the drawings. In the plurality of drawings, the same reference numbers are sometimes given to corresponding elements and redundant explanation thereof is omitted. A plurality of names may be assigned to various elements. However, the provided examples are merely illustrative, and other names may also be used. This applies both to elements with multiple names and to those with only one. Connection sometimes includes not only a direct connection but also a connection via other elements. Unless explicitly described as plural, an element may be interpreted as either singular or plural.

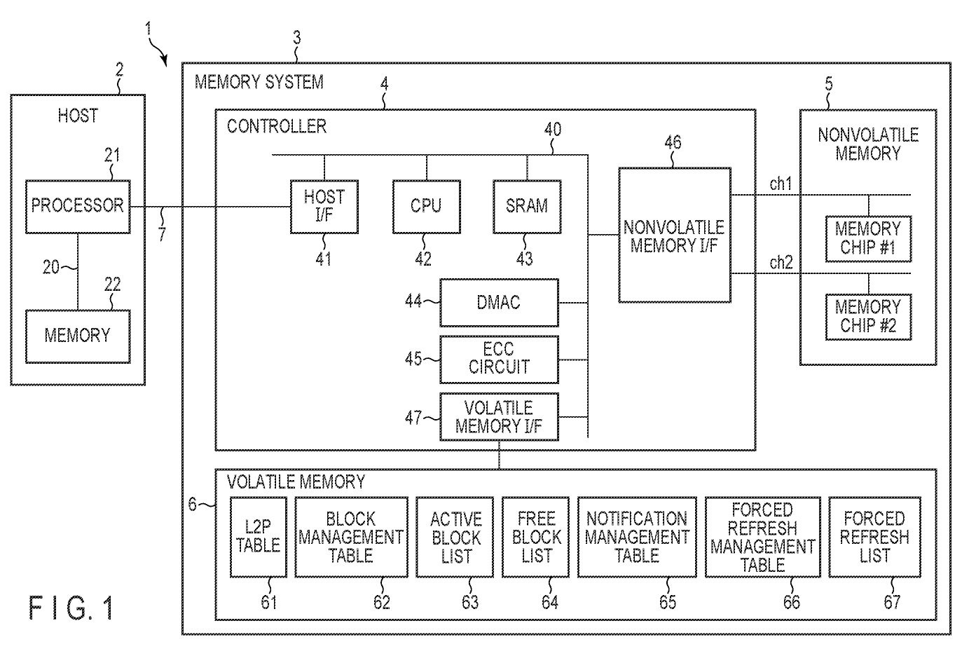

A configuration of a memory system according to the embodiment is explained below with reference to the drawings. FIG. 1 is a block diagram illustrating a configuration example of an information processing system 1 including a memory system 3 according to the embodiment.

The information processing system 1 includes a host (a host device) 2 and the memory system 3.

The host 2 is an information processing device configured to control the memory system 3. An example of the host 2 is a personal computer, a server computer, a portable terminal, or in-vehicle equipment.

The memory system 3 is a semiconductor storage device configured to write data in a nonvolatile memory 5 and read data from the nonvolatile memory 5. The memory system 3 can be implemented as, for example, an SD™ card, a universal flash storage (UFS) device, or a solid state drive (SSD).

Communication between the host 2 and the memory system 3 is executed via a bus 7. The bus 7 is, for example, a PCI express™ (PCIe™) bus. As the standard for a logical interface between the host 2 and the memory system 3, the NVM express™ (NVMe™) standard is used, for example.

The host 2 transmits data and an input/output (I/O) command to the memory system 3 via the bus 7. The memory system 3 transmits data and a response to the host 2 via the bus 7. The I/O command is a command for writing data in the nonvolatile memory 5 or reading data from the nonvolatile memory 5. The I/O command is, for example, a write command or a read command.

The write command is a command for requesting the memory system 3 to write user data (write data) in the nonvolatile memory 5. The write command includes information representing, for example, a namespace identifier, a start logical address, a size of write data, and a data pointer. The namespace identifier is an identifier for identifying a namespace of a write destination. The start logical address is a logical address of the head of the write destination in the namespace of the write destination. The size is a size of write data correlated with the write command. The data pointer represents a position in a memory 22 of the host 2 in which the write data is stored.

The logical address is an address used by the host 2 to access the memory system 3. As the logical address, for example, a logical block address (LBA) is used. The LBA is a logical address used to refer to data of a unit called sector. The size of a sector that can be designated by the LBA is, for example, 512 bytes (B), 4 kilobytes (KB), 8 KB, or 16 KB.

The size of the write data is represented by, for example, the number of LBAs (the number of sectors).

The read command is a command to read data from the memory system 3. The read command includes information representing a namespace identifier, a start logical address, a size of read data, and a data pointer. The namespace identifier is an identifier for identifying a namespace of a read target. The start logical address is a logical address of the head of the read target in the namespace of the read target. The size is a size of read data to be read according to the read command. The data pointer represents a position in the memory 22 of the host 2 to which the read data is to be transferred.

The size of the read data is represented by, for example, the number of LBAs (the number of sectors).

Next, a configuration example of the host 2 is explained. The host 2 includes a processor 21 and the memory 22. The processor 21 and the memory 22 are connected via a bus 20.

The processor 21 is, for example, a central processing unit (CPU). The processor 21 executes software (host software) loaded in the memory 22. The host software is loaded in the memory 22 from the memory system 3 or another storage device connected to the host 2. The host software includes one or more of an operating system, a file system, a device driver, and an application program. The processor 21 can execute a plurality of applications.

The memory 22 is, for example, a volatile memory. The memory 22 is called main memory, system memory, or host memory as well. The memory 22 is a random access memory such as a dynamic random access memory (DRAM). A part of a storage region of the memory 22 is used as a data buffer. Write data that is to be written in the memory system 3 by the host 2 or read data transferred from the memory system 3 is stored in the data buffer.

Next, a configuration example of the memory system 3 is explained. The memory system 3 includes a controller 4, the nonvolatile memory 5, and a volatile memory 6.

The controller 4 is a memory controller that controls the nonvolatile memory 5. The controller 4 may be implemented by a circuit such as a system-on-a-chip (SoC). Functions of the units in the controller 4 are implemented by a dedicated hardware circuit, a processor that executes a program (firmware), or a combination thereof. The controller 4 is electrically connected to the nonvolatile memory 5.

An example of the nonvolatile memory 5 is a NAND flash memory. The nonvolatile memory 5 includes one or more memory chips. The memory chip is also referred to as, for example, flash die or memory die. Each of the memory chips includes a memory cell array. The memory cell array includes a plurality of memory cells arranged in a matrix. The nonvolatile memory 5 may be a memory having a two-dimensional structure or may be a memory having a three-dimensional structure.

An example of the volatile memory 6 is a DRAM. A storage region of the volatile memory 6 is used for, for example, storage of information for managing the memory system 3. A part of the storage region of the volatile memory 6 may be used to temporarily store write data to be written in the nonvolatile memory 5 or read data read from the nonvolatile memory 5.

The controller 4 includes a host interface circuit (host I/F) 41, a CPU 42, a static RAM (SRAM) 43, a direct memory access controller (DMAC) 44, an ECC circuit 45, a nonvolatile memory interface circuit (nonvolatile memory I/F) 46, and a volatile memory interface circuit (volatile memory I/F) 47. The host I/F 41, the CPU 42, the SRAM 43, the DMAC 44, the ECC circuit 45, the nonvolatile memory I/F 46, and the volatile memory I/F 47 are connected to one another via an internal bus 40.

The host I/F 41 is configured to execute communication with the host 2. The host I/F 41 is, for example, a PCIe controller. The host I/F 41 receives various commands from the host 2. These commands are, for example, NVMe commands specified according to the NVMe standard.

The CPU 42 is a processor. The CPU 42 controls the host I/F 41, the SRAM 43, the DMAC 44, the ECC circuit 45, the nonvolatile memory I/F 46, and the volatile memory I/F 47. The CPU 42 loads a control program (firmware) into the SRAM 43 from the nonvolatile memory 5 or a not-illustrated ROM in response to a power-on (boot-up) time of the memory system 3. Then, the CPU 42 performs various kinds of processing by executing the loaded firmware. Note that the firmware may be loaded into the volatile memory 6 instead of the SRAM 43. The CPU 42 can execute command processing for processing various commands from the host 2.

The CPU 42 performs, for example, as a flash translation layer (FTL), management of data stored in the nonvolatile memory 5 and management of a block included in the nonvolatile memory 5. The management of the data stored in the nonvolatile memory 5 includes, for example, management of mapping information. The CPU 42 manages the mapping information using a logical to physical address conversion table (L2P table) 61. The mapping information is information representing mapping between each of logical addresses and each of physical addresses of the nonvolatile memory 5. The physical address is an address representing a physical storage location in the nonvolatile memory 5.

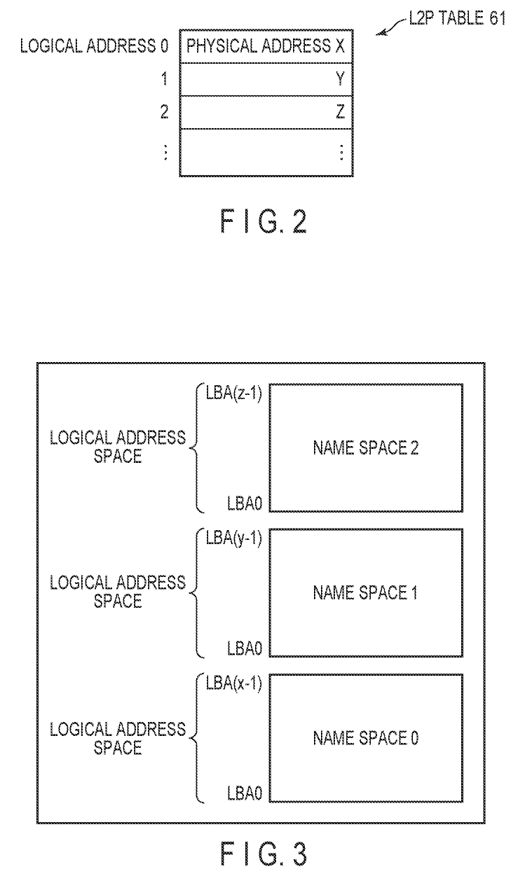

FIG. 2 is a diagram for explaining an example of the L2P table 61. The L2P table 61 manages mapping between each of logical addresses and each of physical addresses. The L2P table 61 manages the mapping, for example, in sector units. A physical address mapped to a certain logical address represents a physical storage location of the nonvolatile memory 5 in which data of the logical address is written. The L2P table 61 may be loaded into the volatile memory 6 from the nonvolatile memory 5 at the power-on (boot-up) time of the memory system 3.

The CPU 42 creates and manages a plurality of namespaces. Each of the plurality of namespaces is a set of logical addresses. The plurality of namespaces are used to cause one memory system to logically operate as a plurality of memory systems. Each of the plurality of namespaces is used by the host 2 in order to access the memory system 3. Each of the plurality of namespaces is identified by a namespace identifier.

The management of the block executed by the CPU 42 includes management of a bad block included in the nonvolatile memory 5, wear leveling, and garbage collection.

FIG. 3 is a diagram for explaining the plurality of namespaces managed in the memory system 3.

FIG. 3 exemplifies a case in which the controller 4 manages a namespace 0, a namespace 1, and a namespace 2. Each namespace is identified by a namespace identifier (NSID). Each namespace includes a set of a plurality of continuous logical addresses (LBAs). The minimum value of the LBA in a logical address space corresponding to each namespace is 0. A size of each namespace can be optionally set. A size of a certain namespace is represented by a value obtained by multiplying the number of LBAs included in the namespace by a data size per LBA. The data size per LBA can be individually set for each of namespaces. Note that, in the following explanation, an LBA having a value n is sometimes described as LBAn. Here, n is an integer equal to or larger than 0.

In an example illustrated in FIG. 3, the namespace 0 includes a set of continuous LBAs from an LBA0 to an LBA(x-1). The namespace 1 includes a set of continuous LBAs from an LBA0 to an LBA(y-1). The namespace 2 includes a set of continuous LBAs from an LBA0 to an LBA(z-1).

Referring back to FIG. 1, the SRAM 43 is a volatile memory. A part of a storage region of the SRAM 43 is used as a work region of the CPU 42. Another part of the storage region of the SRAM 43 can be used as a data buffer in which data that is to be written in the nonvolatile memory 5 or data read from the nonvolatile memory 5 is temporarily stored.

The DMAC 44 is configured to execute direct memory access (DMA). The DMAC 44 executes data transfer between the memory 22 of the host 2 and the SRAM 43 or the volatile memory 6.

The ECC circuit 45 is configured to execute encode processing or decode processing. The ECC circuit 45 executes the encode processing when data is written in the nonvolatile memory 5. In the encode processing, the ECC circuit 45 adds a redundant code (parity) to the data to be written in the nonvolatile memory 5. The redundant code is, for example, an error correction code (ECC). When data is read from the nonvolatile memory 5, the ECC circuit 45 executes the decode processing. In the decode processing, the ECC circuit 45 executes error correction for the data read from the nonvolatile memory 5. When executing the error correction, the ECC circuit 45 uses an ECC added to the data.

The nonvolatile memory I/F 46 is configured to control the nonvolatile memory 5. The nonvolatile memory I/F 46 is electrically connected to a plurality of memory chips included in the nonvolatile memory 5.

The plurality of memory chips is capable of independently operating. That is, the memory chips function as units capable of operating in parallel. The nonvolatile memory I/F 46 is connected to each of channels ch1 and ch2. The nonvolatile memory I/F 46 is connected to one or a plurality of memory chips via a channel or channels corresponding to the plurality of memory chips. In FIG. 1, a case in which one memory chip is connected to each of the channels ch1 and ch2 is given as an example. In this case, the nonvolatile memory I/F 46 is connected to a memory chip #1 via the channel ch1. The nonvolatile memory I/F 46 is connected to a memory chip #2 via the channel ch2. A case in which two memory chips are present in the nonvolatile memory 5 and channels to which the nonvolatile memory I/F 46 is connected are two channels, is explained above. However, the memory chips may be three or more memory chips and the channels may be three or more channels. Two or more memory chips may be connected to one channel.

In a configuration of the nonvolatile memory 5 illustrated in FIG. 1, the controller 4 can access the memory chips #1 and #2 in parallel via the two channels. That is, the controller 4 can execute the writing of data in and the reading of data from the two memory chips #1 and #2 in parallel. In this case, the number of parallel accesses is two. Note that each of the memory chips #1 and #2 may have a multiplane configuration including a plurality of planes. For example, when each of the memory chips #1 and #2 includes four planes, the controller 4 can execute the writing of data in and the reading of data from eight planes in parallel. In this case, the number of parallel accesses is eight.

The volatile memory I/F 47 is configured to control the volatile memory 6.

A part of the storage region of the volatile memory 6 can be used to store information for managing the memory system 3. For example, the volatile memory 6 stores the L2P table 61, a block management table 62, an active block list 63, a free block list 64, a notification management table 65, a forced refresh management table 66, and a forced refresh list 67.

The block management table 62 is a table for managing a physical block and a super block in the memory system 3. A configuration of the super block is explained below. The block management table 62 includes, for example, information concerning a defective block among physical blocks in the memory system 3 and information concerning a plurality of physical blocks that make up each super block. The defective block is a block in which data reading or writing cannot be normally executed. The defective block can also be referred to as bad block.

The active block list 63 is a list of super blocks including valid data. Valid data is data stored in a storage location indicated by a physical address mapped to a logical address. For example, data stored in a storage location represented by a physical address referred to by the L2P table 61 is valid data. Valid data is data that is likely to be read by the host 2.

The free block list 64 is a list of super blocks that store only invalid data. Invalid data is data stored in a storage location indicated by a physical address not mapped to a logical address. For example, data stored in a storage location represented by a physical address not referred to by the L2P table 61 is invalid data. In addition, invalid data is data for which there is no likelihood of its being read from the host 2 anymore.

The notification management table 65, the forced refresh management table 66, and the forced refresh list 67 are used in connection with a notification function of the memory system 3. The notification function is a function performed by the memory system 3 to transmit, to the host 2, presence or absence of a schedule of forced refresh and a start time of the forced refresh. Details of the notification function are explained below.

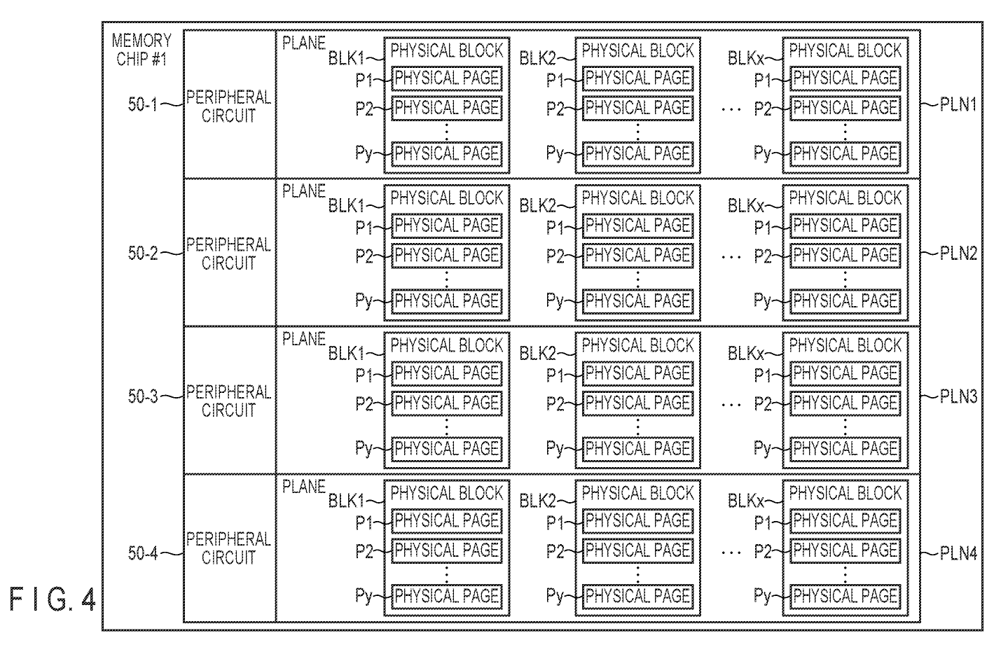

Next, an internal configuration example of the memory chips #1 and #2 is explained. FIG. 4 is a diagram illustrating a configuration example of the memory chips #1 and #2 included in the memory system 3 according to the embodiment. In FIG. 4, the configuration of only the memory chip #1 is given as an example and explained. However, the memory chip #2 can also have the same configuration as the configuration of the memory chip #1.

The memory chip #1 includes four planes (a plane PLN1, a plane PLN2, a plane PLN3, and a plane PLN4) and four peripheral circuits (a peripheral circuit 50-1, a peripheral circuit 50-2, a peripheral circuit 50-3, and a peripheral circuit 50-4) respectively corresponding to the four planes.

Each of the planes PLN1 to PLN4 includes a memory cell array. The memory cell array of each of the planes PLN1 to PLN4 includes a plurality of physical blocks (a physical block BLK1 to a physical block BLKx). Each of the plurality of physical blocks is a unit of a data erase operation. Each of the plurality of physical blocks is also referred to as flash block or memory block. Each of the plurality of physical blocks includes a plurality of physical pages (a page P1 to a page Py). Each of the plurality of physical pages is a unit of a data write operation and a data read operation. Each of the plurality of physical pages includes, for example, a plurality of memory cells connected to the same word line.

Each of the peripheral circuit 50-1 to the peripheral circuit 50-4 is a circuit that controls a memory cell array of a plane corresponding to the peripheral circuit. Each of the peripheral circuit 50-1 to the peripheral circuit 50-4 includes, for example, a row decoder, a column decoder, a sense amplifier, and a page buffer. Each of the peripheral circuit 50-1 to the peripheral circuit 50-4 executes the data write operation, the data read operation, or the data erase operation on the memory cell array of the plane corresponding to the peripheral circuit, in response to an address and a command being received from the nonvolatile memory I/F 46.

Next, a super block and a super page are explained.

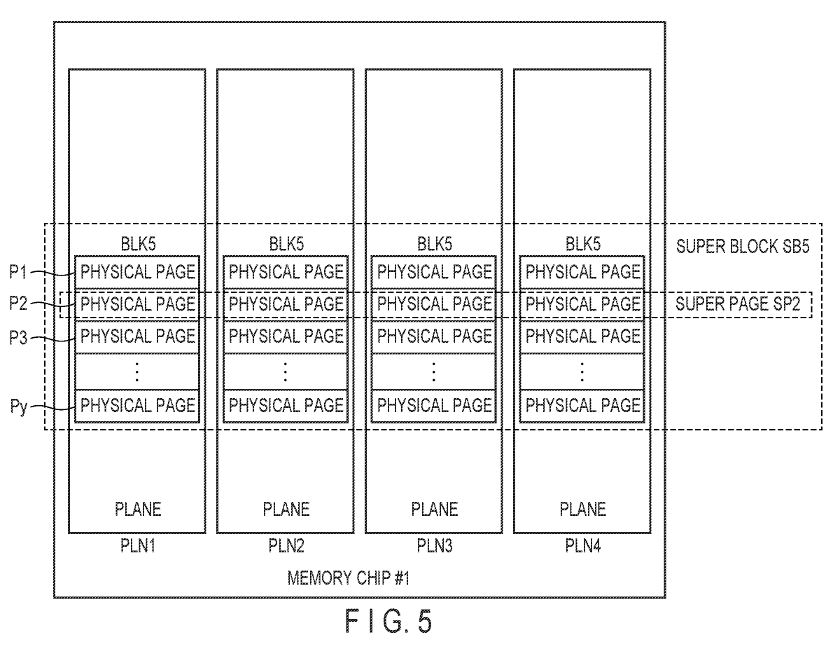

FIG. 5 is a diagram illustrating a configuration example of a super block in the memory system 3 according to the embodiment. The controller 4 manages a set of physical blocks as the super block. The super block is, for example, a set of physical blocks selected one by one from each of planes capable of operating in parallel. The super block is also referred to as logical block or block group. The controller 4 manages, as a super page, a set of physical pages respectively selected from a plurality of physical blocks that make up the super block. The super page is also referred to as logical page or page group. Here, a case in which the super block is made up of physical blocks selected one by one from each of the four planes PLN1 to the plane PLN4 included in the memory chip #1 is explained.

One super block SB includes four physical blocks in total selected one by one from each plane of the memory chip #1. When the nonvolatile memory 5 includes a plurality of memory chips capable of operating in parallel, one super block also may include physical blocks selected one by one from each plane of each memory chip.

In FIG. 5, one super block SB5 including four physical blocks BLK5 is given as an example. Here, the super block SB5 is made up of physical blocks BLK5 of each of the planes PLN1 to PLN4 of the memory chip #1.

The controller 4 can execute data erase processing in a unit of a super block. That is, when all pieces of data stored in the super block SB5 are invalid data, the controller 4 executes the data erase processing on the super block SB5. In the data erase processing for the super block SB5, the data erase operation is executed on each of the four physical blocks BLK5 included in the super block SB5.

In addition, the controller 4 can execute the data write operation in parallel on a plurality of physical blocks of a super block. In the data write operation, the controller 4 writes data in a super page that is a set of physical pages selected one by one from each of the plurality of physical blocks. At this time, the controller 4 can write a redundant code (parity) in at least one physical page among a plurality of physical pages that make up the super page.

In FIG. 5, a set of physical pages P2 of each of the physical blocks BLK5 configuring the super block SB5 makes up a super page SP2. For example, a parity for restoring data stored in the super page SP2 can be written in the physical page P2 of the physical block BLK5 of the plane PLN4.

Next, the notification function of the memory system 3 is explained.

The memory system 3 sometimes moves data stored in a block of the nonvolatile memory 5 to another block. The block may be a physical block or a super block. The movement is referred to as internal movement. The memory system 3 executes the internal movement independently of a command of the host 2.

An example of the internal movement is forced refresh to protect against a data retention error. Each of a plurality of memory cells included in the nonvolatile memory 5 accumulates electric charges in a charge trap layer to store data according to a threshold voltage of the memory cell. As time elapses, the electric charges leak out of the charge trap layer and the amount of electric charges accumulated in the charge trap layer decreases. When the electric charge amount decreases to a certain amount or less, data cannot be correctly read from the memory cell. The time it takes for the electric charge amount to decrease to the certain amount or less is referred to as retention limit time. The memory system 3 moves data to another block before the retention limit time has elapsed from a start time of writing the data. Accordingly, a read error is prevented.

Another example of the internal movement is wear leveling. An ability to accumulate electric charges of the charge trap layer of each of the plurality of memory cells included in the nonvolatile memory 5 is deteriorated with an increase in the number of times a data erase operation is executed. In order to make uniform the number of times of the data erase operation is executed across all blocks, the controller 4 reads data from a block having a small number of the data erase operations executed and writes the read data into a block having a large number of the data erase operations executed.

On the other hand, the host 2 sometimes recognizes that data corresponding to a certain logical address is unnecessary. In this case, the host 2 transmits a deallocate command designating the logical address to the memory system 3. The controller 4 cancels mapping of the logical address to a physical address representing a physical storage location where the data is stored and manages the data as invalid data.

The host 2 is not aware of when the internal movement occurs. For that reason, immediately after the memory system 3 internally moves certain data, the host 2 sometimes transmits a deallocate command for the data. In this case, the internal movement is performed unnecessarily.

If the host 2 acquires the timing of the internal movement in advance, the host 2 can transmit the deallocate command to the memory system 3 before the internal movement. Accordingly, the memory system 3 can avoid execution of unnecessary internal movements. The controller 4 according to the embodiment transmits a schedule of internal movement to the host 2 using the notification function.

In the following explanation, a case in which the internal movement is forced refresh is given as an example. The embodiment can also be applied to a case in which the internal movement is wear leveling.

The host 2 transmits an inquiry concerning a schedule of the forced refresh to the memory system 3. In response to the inquiry, the memory system 3 transmits the schedule of the forced refresh to the host 2. The schedule of the forced refresh specifies a start time of the forced refresh. The start time can be represented by the time of day or an elapsed time from the current time set to 0. In the following explanation, the start time is represented by the elapsed time from the current time set to 0. The schedule represents, for example, how many hours from the current time the forced refresh is to be started.

When the memory system 3 transmits a schedule of forced refresh for all data to the host 2, traffic between the memory system 3 and the host 2 undesirably increases. In order to cope with this, in the embodiment, only a schedule of forced refresh that is to be started within a specific time from the current time for data corresponding to a certain notification setting range is transmitted. This specific time is referred to as notification setting time. The host 2 transmits a setting command for setting a notification setting range and a notification setting time corresponding to the notification setting range to the memory system 3. Note that, when desiring to acquire schedules of all forced refresh in a certain notification setting range, the host 2 sets the notification setting time corresponding to the notification setting range to an extremely long time. Alternatively, the host 2 may disable the setting of the notification setting time.

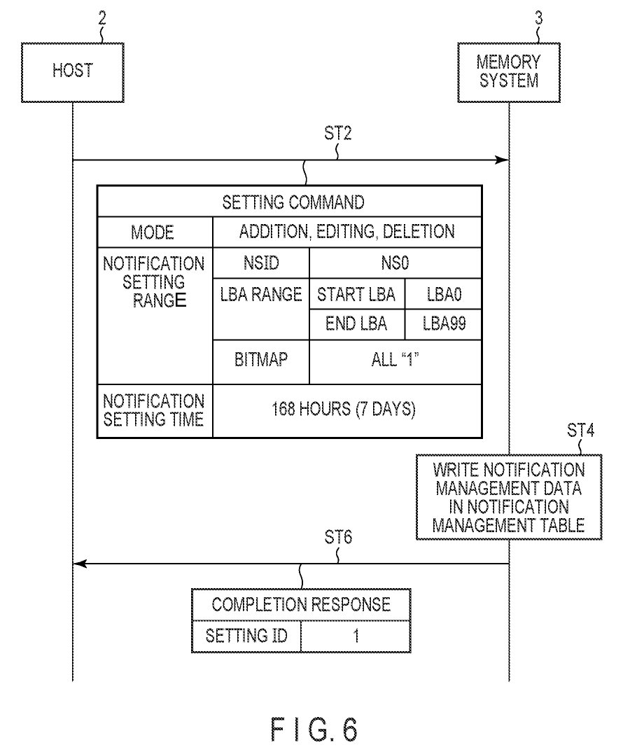

FIG. 6 is a diagram for explaining an example of processing of the memory system 3 in the case in which the memory system 3 receives a setting command from the host 2.

The host 2 transmits a setting command to the memory system 3 (ST2). The setting command is a command for requesting the memory system 3 to create notification management data including a notification setting range and a notification setting time. The notification management data is data that is used in creating a notification that the memory system 3 transmits to the host 2. Details of the notification management data are explained below.

The setting command includes information representing a mode, information representing a notification setting range, and information representing a notification setting time. The mode is addition, editing, or deletion. The addition means creating notification management data anew. The editing means collecting a plurality of pieces of notification management data into one notification management data. The deletion means deleting notification management data that is no longer necessary.

The notification setting range is an identifier for indicating a logical address range that is a target of the notification. For example, the notification setting range includes namespace identification information (NSID) and an LBA range. The LBA range includes, for example, a start LBA and an end LBA.

When the memory system 3 is adapted to include a multi-stream function or a flexible data placement function, the notification setting range can further include a stream identifier or a reclaim unit handler (RUH). In this case, the information representing the notification setting range can include a bitmap representing the stream identifier or the RUH. The bitmap is, for example, 16-bit data. For example, when a certain bit of the bitmap is set to "1", data of a stream identifier or an RUH corresponding to the bit is a target of the notification. When a certain bit of the bitmap is set to "0", data of a stream identifier or an RUH corresponding to the bit is not a target of the notification.

The host 2 determines the notification setting time for each notification setting range.

The controller 4 (specifically, for example, the CPU 42) creates notification management data for managing the setting designated by the setting command. The controller 4 writes the notification management data in one entry of the notification management table 65 (ST4).

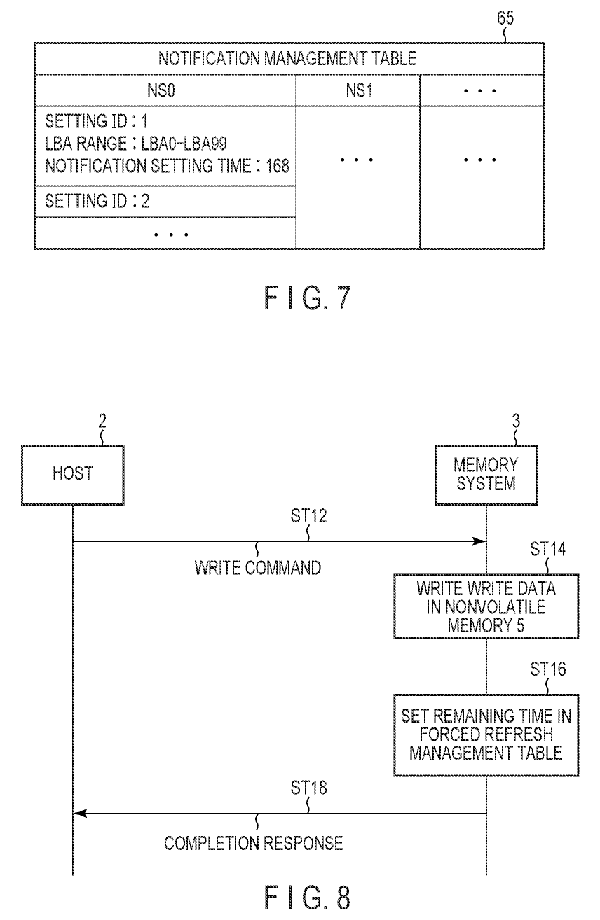

FIG. 7 is a diagram for explaining an example of the notification management table 65. The notification management table 65 includes an entry for each namespace. The notification management data is created for each namespace corresponding to the namespace identifier designated by the setting command. One entry may include a plurality of pieces of notification management data. The notification management data includes the LBA range and the notification setting time designated by the setting command. The notification management data may further include information concerning the bitmap. The CPU 42 adds a setting ID to the notification management data created according to the setting command. The CPU 42 writes the notification management data added with the setting ID in the notification management table 65.

In the example illustrated in FIG. 7, notification management data, the setting ID of which is 1, includes information concerning data stored in an LBA range from LBA0 to LBA99 of a namespace, the namespace identifier of which is NS0. The notification setting time of the notification management data designated by the host 2 is 168 hours (seven days).

Referring back to FIG. 6, the controller 4 transmits a completion response to the host 2 (ST6). The completion response includes the setting ID corresponding to an entry added to the notification management data. The host 2 manages, using the setting ID, the notification management data designated by the setting command.

FIG. 8 is a diagram for explaining an example of processing of the memory system 3 in the case in which a write command is received. The host 2 transmits the write command to the memory system 3 (ST12).

The controller 4 writes write data in the nonvolatile memory 5 in response to receiving the write command (ST14). Here, it is assumed that the namespace identifier included in the write command is NS0, the start LBA is LBA0, and the size of the write data is 100 sectors (that is, an LBA range designated by the write command is LBA0 to LBA99).

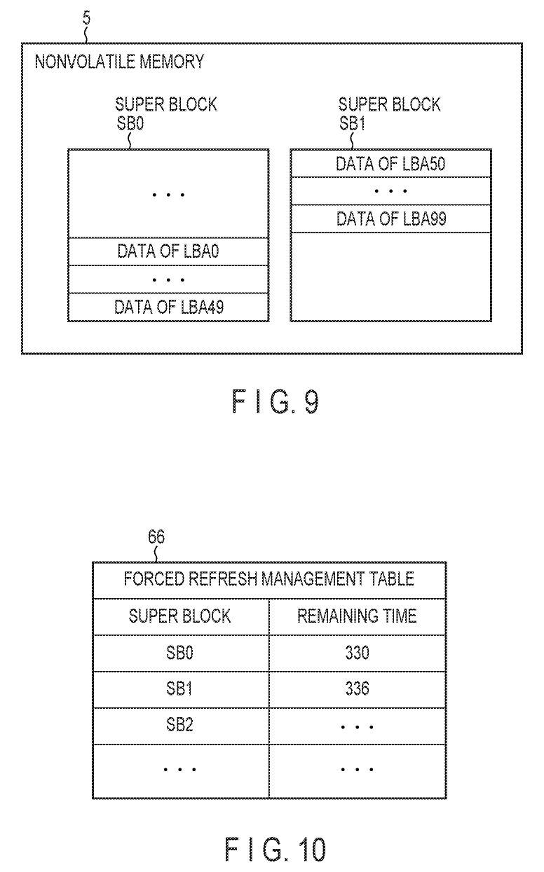

FIG. 9 is a diagram for explaining an example of the nonvolatile memory 5 in which data is written according to the write command. It is assumed that, before the write command is received, in a super block SB0, data is already written in a part of the storage regions, and the remaining storage regions are free space and, in a super block SB1, all storage regions are free space. The controller 4 sequentially writes data of LBA0 to LBA49 in the free space of the super block SB0. It is assumed that the data of the LBA49 is written in the super block SB0, whereby the free space of the super block SB0 has been used. Thereafter, the controller 4 sequentially writes data of LBA50 to LBA99 in the super block SB1.

FIG. 10 is a diagram for explaining an example of the forced refresh management table 66. The forced refresh management table 66 stores a remaining time until a forced refresh starts for each super block. At a start time of the first writing in each super block, the CPU 42 sets an initial value for the remaining time of the forced refresh management table 66. Here, the first writing in a certain super block means writing executed first after the data erase operation is executed on the super block. The controller 4 includes a timer (not shown). The remaining time is managed using the timer and is decreased as time elapses. The CPU 42 starts forced refresh for the super block for which the remaining time has decreased to 0.

The forced refresh for the super block needs to be completed before the retention limit time elapses from the start time of the first writing in the super block. For that reason, the initial value of the remaining time is a time shorter than the retention limit time. However, when the initial value of the remaining time is a time much shorter than the retention limit time, the number of times of the forced refresh undesirably increases.

A timing of the first writing is different for each super block. For that reason, a plurality of super blocks do not simultaneously reach the retention limit time. However, since a certain degree of time is required for the forced refresh, even during the forced refresh for a certain super block, a remaining time of one or more other super blocks continues to decrease. A start of the forced refresh for the other super blocks is kept waiting until the forced refresh currently being executed is completed. Even when the start of the forced refresh is delayed in this way, the forced refresh needs to be completed for all the super blocks before the retention limit time elapses from the first writing.

For example, when a time required for the forced refresh for one super block is one minute and the number of super blocks managed by the controller 4 is 1024, a time required for the forced refresh for all the super blocks is approximately seventeen hours. For that reason, if the initial value of the remaining time is a time obtained by subtracting seventeen hours from the retention limit time, for all the super blocks, it is guaranteed that the forced refresh is completed before the retention limit time elapses from the first writing. Note that the CPU 42 may secure some margin and sets, as the initial value of the remaining time, for example, a time obtained by subtracting twenty-four hours from the retention limit time. For example, when the retention limit time is 360 hours (fifteen days) and some margin is secured, the initial value of the remaining time is 336 hours (fourteen days).

FIG. 10 illustrates a state of the forced refresh management table 66 immediately after data of LBA50 is written in the super block SB1. The initial value (336 hours) is set for the remaining time of the super block SB1. In addition, it is assumed that the start time of the first writing to the super block SB0 is six hours before the start time of the first writing to the super block SB1. For that reason, the remaining time of the super block SB0 is 330 hours obtained by subtracting six hours from the initial value.

Referring back to FIG. 8, as explained with reference to FIG. 10, the controller 4 that has written the write data in the nonvolatile memory 5 sets, in the forced refresh management table 66, the remaining time of a super block in which the first writing has been started (ST16). Then, the controller 4 transmits a completion response to the host 2 (ST18).

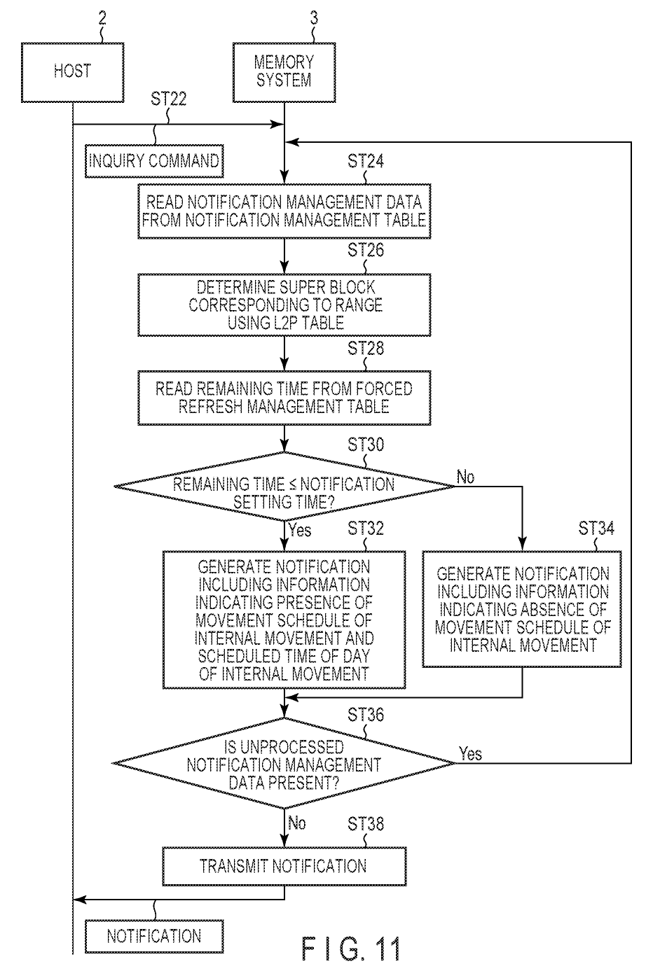

FIG. 11 is a diagram for explaining an example of processing of the memory system 3 in the case in which an inquiry command is received. When receiving the inquiry command from the host 2, the memory system 3 transmits a notification representing a schedule of forced refresh to the host 2.

The host 2 transmits the inquiry command to the memory system 3 at any timing (ST22). The host 2 may periodically transmit the inquiry command to the memory system 3 at a constant interval. Alternatively, the host 2 may transmit the inquiry command to the memory system 3 at a time when traffic between the host 2 and the memory system 3 is low. The inquiry command designates one or more setting IDs of notification management data transmitted to the host 2 in the completion response of a setting command.

The controller 4 reads, from the notification management table 65, one entry of notification management data corresponding to the setting ID designated by the inquiry command (ST24). The controller 4 determines, using the L2P table 61, one or more super blocks corresponding to the notification setting range of the notification management data (ST26). The controller 4 reads the remaining time of the determined super blocks from the forced refresh management table 66 (ST28).

The host 2 desires to acquire a schedule of forced refresh that will be started before the notification setting time elapses since the inquiry command is transmitted. For that reason, the controller 4 determines whether the remaining time is the notification setting time or shorter (ST30). When the remaining time is the notification setting time or shorter (Yes in ST30), it is assumed that the forced refresh will be started before the notification setting time elapses since the inquiry command is received. For that reason, the controller 4 generates a notification including information indicating that a schedule of the internal movement (e.g., forced refresh) is present and information indicating a scheduled time of day of the internal movement (ST32). The remaining time of the target super block is set in the scheduled time of the internal movement. Note that, when it is assumed that the forced refresh will be started for two or more super blocks, the notification may include two or more scheduled times of the internal movement.

When the remaining time is longer than the notification setting time (No in ST30), it is assumed that the forced refresh will not be started before the notification setting time elapses since the inquiry command is received. For that reason, the controller 4 generates a notification including information indicating that a schedule of internal movement is absent (ST34).

After the processing in step ST32 or step ST34, the controller 4 determines whether unread notification management data (that is, unprocessed notification management data) corresponding to the one or more setting IDs designated by the inquiry command is present (ST36). When unprocessed notification management data is present (Yes in ST36), the controller 4 reads the next notification management data from the notification management table 65 (ST24).

When unprocessed notification management data is absent (No in ST36), the controller 4 transmits the notification generated in the processing in step ST32 or step ST34 to the host 2 (ST38).

The remaining time of the forced refresh management table 66 decreases as time elapses. For this reason, presence or absence of a schedule of internal movement in the notification can change depending on the timing at which the host 2 transmits the inquiry command.

First, a case in which, at the start time of writing the data of LBA50 in the super block SB1 according to the write command explained with reference to FIGS. 8 to 10, the host 2 transmits an inquiry command for designating 1 in the setting ID is explained. In this case, it is assumed that the forced refresh management table 66 is in the state illustrated in FIG. 10. It is also assumed that the notification management table 65 is in the state illustrated in FIG. 7. That is, the notification management data in which the setting ID is 1 includes NS0 and LBA0 to LBA99 as the notification setting range. The remaining time (330 hours) of the super block SB0 in which the data of LBA0 to LBA49 is written is longer than the notification setting time (168 hours). The remaining time (336 hours) of the super block SB1 in which the data of LBA50 to LBA99 is written is also longer than the notification setting time (168 hours). Therefore, the forced refresh for the notification setting range designated by the inquiry command will not be started before the notification setting time elapses.

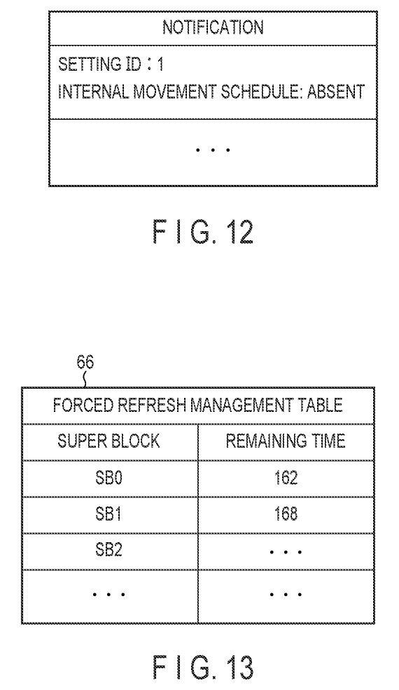

FIG. 12 is a diagram for explaining an example of the notification transmitted to the host 2 in this situation. The notification includes the setting ID (1) and information indicating that a schedule of internal movement is absent.

Next, a case in which, after elapse of seven days (168 hours) from the start of writing the data of LBA50 in the super block SB1 according to the write command explained with reference to FIGS. 8 to 10, the host 2 transmits an inquiry command for designating 1 in the setting ID is explained. In this case, the forced refresh management table 66 is in the state illustrated in FIG. 13. That is, the remaining time of the super block SB0 is 162 hours obtained by subtracting 168 hours from 330 hours illustrated in FIG. 10. The remaining time of the super block SB1 is 168 hours obtained by subtracting 168 hours from 336 hours illustrated in FIG. 10.

In this case, the remaining time (162 hours) of the super block SB0 in which the data of LBA0 to LBA49 is written is shorter than the notification setting time (168 hours). In addition, the remaining time (168 hours) of the super block SB1 in which the data of LBA50 to LBA99 is written is equal to the notification setting time (168 hours). Therefore, the forced refresh for the notification setting range designated by the inquiry command will be started after 162 hours for LBA0 to LBA49 and after 168 hours for LBA50 to LBA99, respectively.

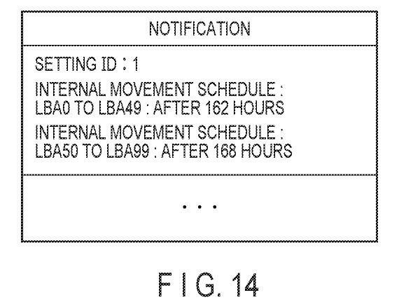

FIG. 14 is a diagram for explaining an example of the notification transmitted to the host 2 in this situation. The notification includes the setting ID (1) and information indicating that internal movement is scheduled to be started after 162 hours for LBA0 to LBA49 and after 168 hours for LBA50 to LBA99, respectively.

As explained above, when receiving the inquiry command from the host 2, the memory system 3 notifies, to the host 2, an identifier of data for which internal movement is to be started within a notification setting time from a command reception time and a scheduled start time of the internal movement. If the data scheduled to be internally moved is unnecessary data, the host 2 that has received the notification can set timing for transmitting a deallocate command for the data to be earlier than the scheduled start time of the internal movement.

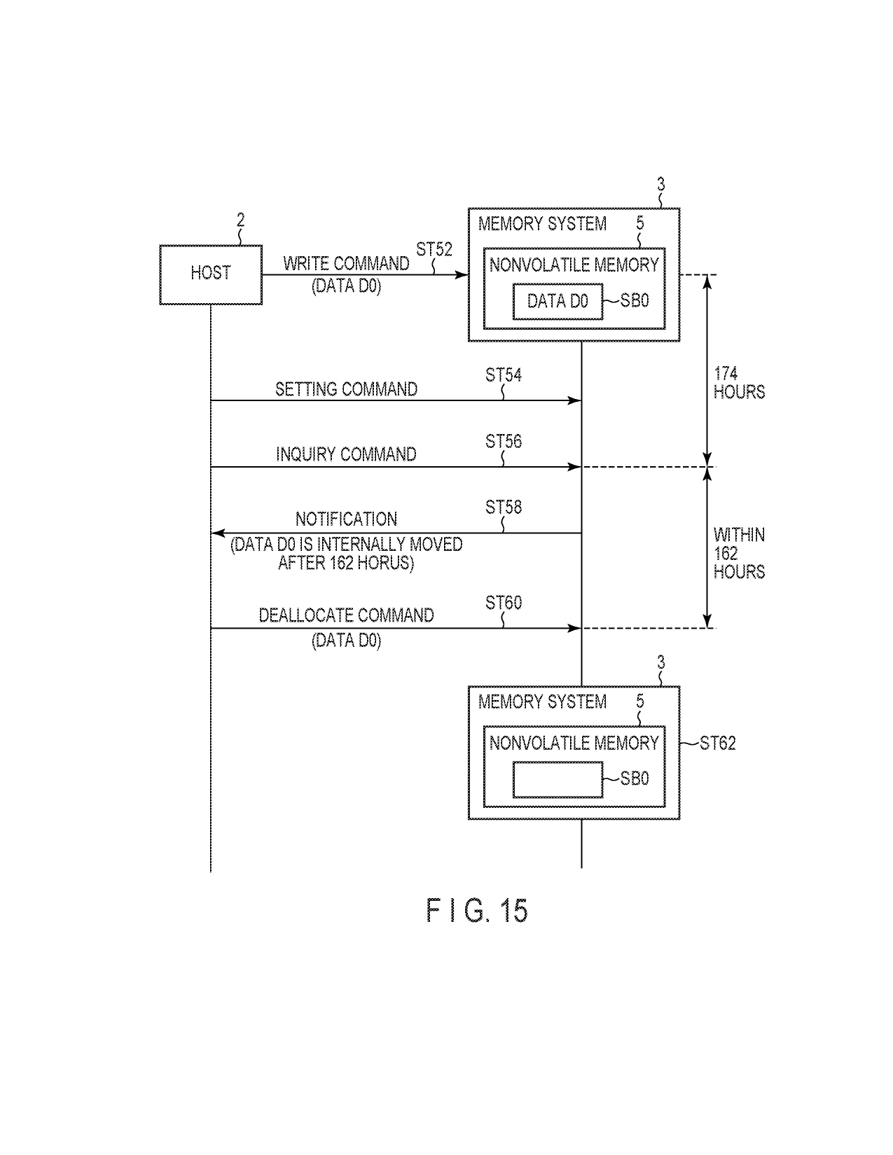

FIG. 15 is a diagram for explaining an example of timing at which the host 2 transmits a deallocate command to the memory system 3 according to the embodiment.

The host 2 transmits a write command concerning data D0 to the memory system 3 (ST52). As explained with reference to FIGS. 8 to 10, the controller 4 writes the data D0 in the nonvolatile memory 5. Here, it is assumed that the controller 4 writes the data D0 in the super block SB0. Although not illustrated in FIG. 15, at a start time of the writing to the super block SB0, the controller 4 sets an initial value for the remaining time of the super block SB0 in the forced refresh management table 66. The initial value is, for example, 336 hours (fourteen days). The controller 4 transmits a completion response to the host 2.

The host 2 transmits a setting command to the memory system 3 (ST54). As explained with reference to FIGS. 6 to 7, the controller 4 writes notification management data in the notification management table 65. The controller 4 transmits a completion response to the host 2. Note that the host 2 may transmit the setting command first and thereafter transmit the write command.

The host 2 transmits an inquiry command to the memory system 3 at any timing (ST56). Here, it is assumed that the inquiry command has been transmitted when 174 hours (seven days and six hours) has elapsed from the start of writing the data D0 to the super block SB0. That is, it is assumed that the inquiry command has been transmitted when the remaining time of the super block SB0 is 162 hours. As explained with reference to FIGS. 11 to 13, the controller 4 compares the remaining time of the forced refresh management table 66 and the notification setting time of the notification management data and determines presence or absence of a schedule of internal movement. In the case of the example illustrated in FIG. 15, the notification includes information indicating that the data D0 is internally moved after 162 hours. The controller 4 transmits a notification including the schedule of the internal movement to the host 2 (ST58).

If the host 2 already recognizes that the data D0 is unnecessary at a point in time when receiving this notification, the host 2 can transmit a deallocate command for the data D0 to the memory system 3 before 162 hours elapses after receiving the notification (ST60). When receiving the deallocate command for the data D0, the controller 4 deallocates the data D0 (ST62). Accordingly, the controller 4 does not execute internal movement of the data D0 scheduled after elapse of 336 hours from the start of the writing to the super block SB0.

As explained above, the memory system 3 according to the embodiment can prevent data unnecessary for the host 2 from being internally moved. Since the number of times of unnecessary internal movement does not increase, a WAF does not excessively rise and the performance of the memory system 3 is not deteriorated.

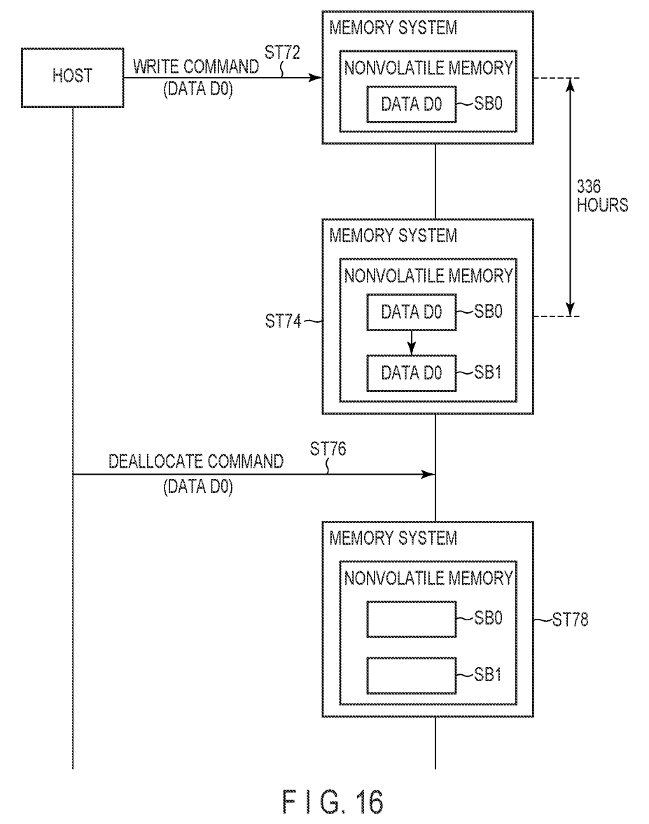

FIG. 16 is a diagram for explaining an example of timing at which a host transmits a deallocate command to a memory system according to a comparative example. In the comparative example, the memory system does not transmit a schedule of internal movement to the host.

The host transmits a write command concerning data D0 to the memory system (ST72). As in the case of the embodiment explained with reference to FIG. 15, a controller of the memory system writes the data D0 in a super block SB0. In a forced refresh management table, an initial value (336 hours) is set for a remaining time of the super block SB0.

When 336 hours have elapsed from the start of writing the data D0 to the super block SB0, the memory system starts forced refresh for the data D0 (ST74). That is, the data D0 is moved from the super block SB0 to a super block SB1.

As explained above, the memory system according to the comparative example does not transmit a schedule of internal movement to the host. Here, it is assumed that, although the host recognizes before the processing in step ST74 that the data D0 is unnecessary, a deallocate command for the data D0 is transmitted to the memory system thereafter (ST76).

The memory system that has received the deallocate command deallocates the data D0 moved to the super block SB1 (ST78).

As explained above, since the memory system according to the comparative example internally moves the data D0 unnecessarily, the WAF excessively rises and the performance is deteriorated.

While the forced refresh is performed, response performance of the memory system to an I/O command from the host is deteriorated. As explained above, when receiving the notification, the host 2 connected to the memory system 3 according to the embodiment can acquire the schedule of the forced refresh. Thus, the host 2 may transmit, to the memory system 3, a request for changing a period of forced refresh in which the performance is deteriorated. This request is referred to as reservation command.

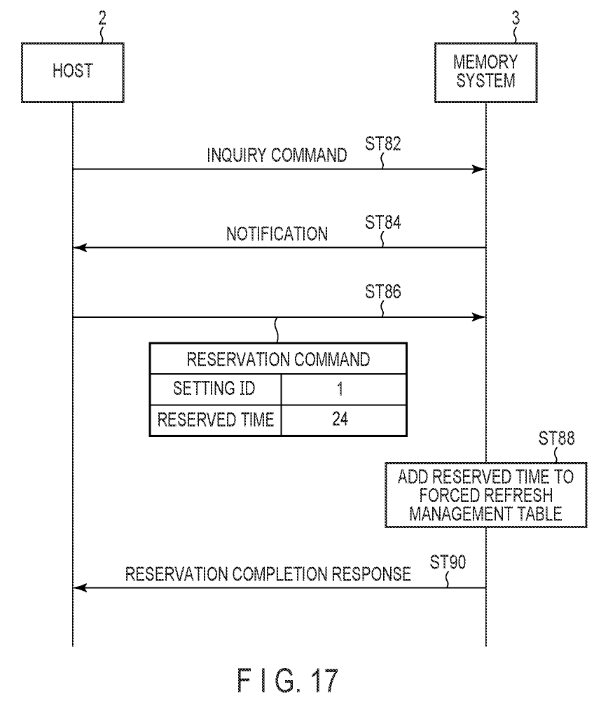

FIG. 17 is a diagram for explaining an example of processing in the case in which the memory system 3 according to the embodiment receives the reservation command.

The host 2 transmits an inquiry command to the memory system 3 at any timing (ST82). The controller 4 that has received the inquiry command transmits a notification to the host 2 (ST84).

The host 2 recognizes, from an internal movement schedule of the notification, a period when the performance of the memory system 3 will be deteriorated. In addition, the host 2 acquires a period during which accesses to the memory system 3 is likely to become concentrated. When the performance deterioration period overlaps the access concentration period, the host 2 transmits the reservation command in order to set a start time of forced refresh in the memory system 3 to be earlier (ST86). The reservation command includes a setting ID and information representing a reserved time. The reserved time represents the number of hours after the current time the host 2 wants the forced refresh to be started.

The controller 4 that has received the reservation command adds an item of the reserved time to the forced refresh management table 66 and writes the reserved time designated by the reservation command in the forced refresh management table 66 (ST88).

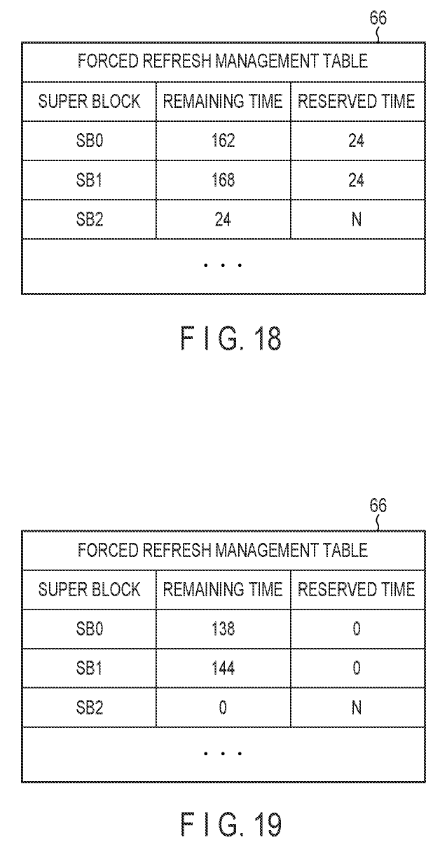

FIG. 18 is a diagram for explaining an example of the forced refresh management table 66 in which the reserved time is written. Here, it is assumed that the reserved time is 24 hours, the remaining time of the super block SB0 is 162 hours, the remaining time of the super block SB1 is 168 hours, and the remaining time of a super block SB2 is 24 hours. It is assumed that super blocks corresponding to the notification setting range of the setting ID designated by the reservation command are only the super block SB0 and the super block SB1. In this case, 24 hours is written in the reserved time of the super block SB0 and 24 hours is written in the reserved time of the super block SB1. Since the reservation command does not include the reserved time for the super block SB2, N (no reservation) is written in an item of the reserved time of the super block SB2. The reserved time is also managed by the timer like the remaining time and decreases as time elapses.

Referring back to FIG. 17, the controller 4 transmits a reservation completion response to the host 2 after setting the reserved time (ST90).

FIG. 19 is a diagram for explaining an example of a state of the forced refresh management table 66 after elapse of 24 hours from the writing of the reserved time. The remaining time of the super block SB0 is 138 hours, the remaining time of the super block SB1 is 144 hours, and the remaining time of the super block SB2 is 0 hours. The reserved times of the super blocks SB0 and SB1 are 0 hours and the reserved time of the super block SB2 is N.

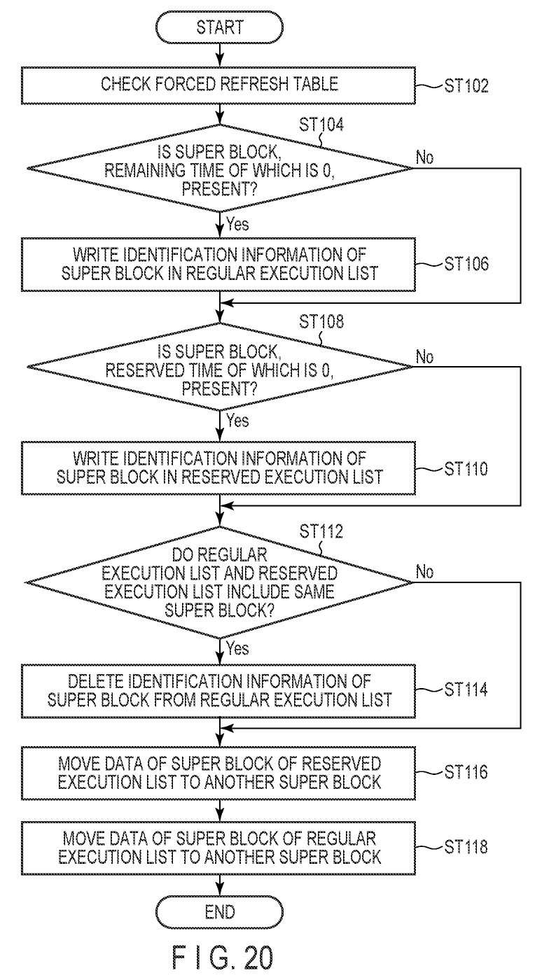

The memory system 3 starts forced refresh based on the forced refresh management table 66. FIG. 20 is a flowchart for explaining an example of a procedure of the forced refresh by the memory system 3.

The CPU 42 checks content of the forced refresh management table 66 (ST102). The CPU 42 periodically executes the processing in step ST102.

The CPU 42 determines whether a super block, the remaining time of which is 0 in the forced refresh management table 66, is present (ST104).

When a super block, the remaining time of which is 0, is present (Yes in ST104), the CPU 42 writes identification information of the super block in a regular execution list of the forced refresh list 67 (ST106). When a super block, the remaining time of which is 0, is absent (No in ST104), the processing in step ST106 is not executed and the processing by the CPU 42 proceeds to step ST108.

The CPU 42 determines whether a super block, the reserved time of which is 0 in the forced refresh management table 66, is present (ST108).

When a super block, the reserved time of which is 0, is present (Yes in ST108), the CPU 42 writes identification information of the super block in a reserved execution list of the forced refresh list 67 (ST110). When a super block, the reserved time of which is 0, is absent (No in ST108), the processing in step ST110 is not executed and the processing by the CPU 42 proceeds to step ST112.

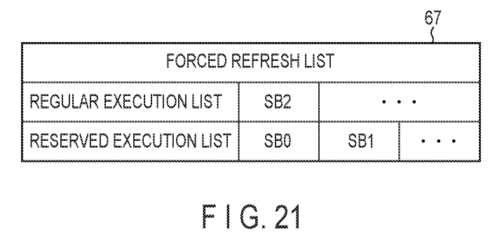

FIG. 21 is a diagram for explaining an example of the forced refresh list 67. The forced refresh list 67 stores identification information of a super block on which forced refresh should be executed. The forced refresh list 67 includes the regular execution list and the reserved execution list. The regular execution list stores identification information of a super block, the remaining time of which is 0. The reserved execution list stores identification information of a super block, the reserved time of which is 0.

Referring back to FIG. 20, the CPU 42 determines whether the regular execution list and the reserved execution list include identification information of the same super block in the forced refresh list 67 (ST112).

When the regular execution list and the reserved execution list include identification information of the same super block (Yes in ST112), the CPU 42 deletes the identification information of the super block from the regular execution list (ST114). The identification information of the super block is stored only in the reserved execution list in such cases. When the regular execution list and the reserved execution list do not include identification information of the same super block (No in ST112), the processing in step ST114 is not executed and the processing by the CPU 42 proceeds to step ST116.

The CPU 42 moves data of a super block having the identification information stored in the reserved execution list to another super block (ST116). The processing in step ST116 is sequentially executed for all super blocks, the identification information of which is stored in the reserved execution list.

The CPU 42 moves data of a super block having the identification information stored in the regular execution list to another super block (ST118). The processing in step ST118 is sequentially executed for all super blocks, the identification information of which is stored in the regular execution list.

According to the embodiment, the memory system 3 informs a schedule of forced refresh to the host 2. For that reason, the host 2 can acquire in advance a period when the performance of the memory system 3 will be deteriorated. When the performance deterioration period overlaps a period when accesses to the memory system 3 will likely become concentrated, the host 2 can transmit a reservation command for setting the schedule of the forced refresh to be earlier to the memory system 3. For that reason, the memory system 3 can execute the forced refresh in a period when accesses from the host 2 will not be concentrated.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory including a plurality of storage regions, each of which includes a plurality of memory cells each configured to store data in accordance with a threshold voltage thereof; and
a controller electrically connected to the nonvolatile memory and configured to:
in response to an inquiry command received from a host, the inquiry command including at least a first logical address, determine whether internal movement of first data corresponding to the first logical address is scheduled to be started within a predetermined amount of time from a receipt time of the inquiry command; and
in response to determining that the internal movement of the first data is scheduled to be started within the predetermined amount of time from the receipt time of the inquiry command, transmit schedule information to the host, the schedule information indicating when the internal movement of the first data will be started.

2. The memory system of claim 1, wherein the internal movement of the first data includes:
the controller reading the first data from a first storage region that is one storage region among the plurality of storage regions; and
the controller writing the read first data to a second storage region that is another storage region among the plurality of storage regions.

3. The memory system of claim 2, wherein the controller is further configured to store information representing a correspondence relation between the first logical address and the predetermined amount of time in a first table, in response to receiving, from the host, a setting command that includes at least the first logical address and the predetermined amount of time.

4. The memory system of claim 3, wherein the controller is further configured to:
track, for each of the plurality of storage regions, using a second table, a remaining time; and
start the internal movement of the first data in response to the remaining time tracked for the first storage region, decreasing to zero.

5. The memory system of claim 4, wherein the controller is further configured to, in response to receiving a write command from the host:
write data associated with the write command to a write destination storage region among the plurality of storage regions; and
set the remaining time for the write destination storage region to an initial remaining time in the second table.

6. The memory system of claim 5, wherein the controller is further configured to, in response to receiving the inquiry command from the host:
read the predetermined amount of time corresponding to the first logical address from the first table;
determine the first storage region based on the first logical address included in the inquiry command;
read the remaining time tracked for the first storage region; and
when the read remaining time of the first storage region is less than the read predetermined amount of time corresponding to the first logical address, generate notification information that includes the schedule information for transmission to the host.

7. The memory system of claim 4, wherein the controller is further configured to:
for each of the plurality of storage regions, in response to writing thereto for a first time after a data erasure operation thereon, set the remaining time of said each storage region to an initial remaining time in the second table; and
update the remaining times in the second table according to an amount of elapsed time since a last update thereof.

8. The memory system of claim 7, wherein the initial remaining time is set to a time that is computed by subtracting a total time required for the internal movement executed for all of the plurality of storage regions from a limit time associated with an expected data retention time of the storage regions.

9. The memory system of claim 4, wherein the controller is further configured to:
track, for each of the plurality of storage regions, using the second table, a reserved time; and
start the internal movement of the first data in response to the remaining time tracked for the first storage region or the reserved time tracked for the first storage region, decreasing to zero.

10. The memory system of claim 9, wherein the controller is further configured to:
in response to receiving, from the host, a reservation command including at least the first logical address and an input reserved time, set the reserved time for the first storage region in the second table to be equal to the input reserved time; and
update the remaining times and the reserved times in the second table according to an amount of elapsed time since a last update thereof.

11. The memory system of claim 10, wherein the controller is further configured to:
in response to the remaining time tracked for a third storage region among the plurality of storage regions decreasing to zero, write identification information of the third storage region in a first list and, in response to the reserved time tracked for a fourth storage region among the plurality of storage regions decreasing to zero, write identification information of the fourth storage region in a second list; and
start the internal movement for storage regions, including the fourth storage region, having identification information written in the second list and, thereafter, start the internal movement for storage regions, including the third storage region, having identification information written in the first list.

12. A method of notifying a host of scheduled internal movements of data within a memory system that includes a nonvolatile memory including a plurality of storage regions, each of which includes a plurality of memory cells each configured to store data in accordance with a threshold voltage thereof, said method comprising:
in response to an inquiry command received from the host, the inquiry command including at least a first logical address, determining that internal movement of first data corresponding to the first logical address is scheduled to be started within a predetermined amount of time from a receipt time of the inquiry command; and
in response to determining that the internal movement of the first data is scheduled to be started within the predetermined amount of time from the receipt time of the inquiry command, transmitting schedule information to the host, the schedule information indicating when the internal movement of the first data will be started.

13. The method of claim 12, wherein the internal movement of the first data includes:
reading the first data from a first storage region that is one storage region among the plurality of storage regions; and
writing the read first data to a second storage region that is another storage region among the plurality of storage regions.

14. The method of claim 13, further comprising:
receiving, from the host, a setting command that includes at least the first logical address and the predetermined amount of time; and
in response to receiving the setting command, storing data representing a correspondence relation between the first logical address and the predetermined amount of time, in a first table.

15. The method of claim 14, further comprising:
tracking, for each of the plurality of storage regions, using a second table, a remaining time;
determining that the remaining time tracked for the first storage region decreases to zero; and
starting the internal movement of the first data in response to the remaining time tracked for the first storage region, decreasing to zero.

16. The method of claim 15, further comprising:
receiving a write command from the host; and
in response to receiving the write command:
writing data associated with the write command to a write destination storage region among the plurality of storage regions; and
setting the remaining time for the write destination storage region to an initial remaining time in the second table.

17. The method of claim 16, further comprising:
in response to receiving the inquiry command from the host:
reading the predetermined amount of time corresponding to the first logical address from the first table;
determining the first storage region based on the first logical address included in the inquiry command;
reading the remaining time tracked for the first storage region;
determining that the read remaining time of the first storage region is less than the read predetermined amount of time corresponding to the first logical address; and
in response to determining that the read remaining time of the first storage region is less than the read predetermined amount of time corresponding to the first logical address, generating notification information that includes the schedule information for transmission to the host.

18. The method of claim 15, further comprising:
for each of the plurality of storage regions, in response to writing thereto for a first time after a data erase operation thereon, setting the remaining time of said each storage region to an initial remaining time in the second table; and
updating the remaining times in the second table according to an amount of elapsed time since a last update thereof.

19. The method of claim 18, wherein the initial remaining time is set to a time that is computed by subtracting a total time required for the internal movement executed for all of the plurality of storage regions from a limit time associated with an expected data retention time of the storage regions.

20. The method of claim 15, further comprising:
tracking, for each of the plurality of storage regions, using the second table, a reserved time;
determining that the remaining time tracked for the first storage region or the reserved time tracked for the first storage region decreases to zero; and
starting the internal movement of the first data in response to the remaining time tracked for the first storage region or the reserved time tracked for the first storage region, decreasing to zero.
